(19) United States
(12) Patent Application Publication
(10) Pub. No.: US 2017/0361610 A1
(43) Pub. Date: Dec. 21, 2017

(54) LIQUID EJECTING HEAD AND LIQUID EJECTING APPARATUS

(71) Applicant: SEIKO EPSON CORPORATION, Tokyo (JP)

(72) Inventors: Kazuhiko HARA, Shiojiri-shi (JP); Hiroyuki KOBAYASHI, Azumino-shi (JP); Kinya OZAWA, Shiojiri-shi (JP); Takashi KOASE, Shiojiri-shi (JP)

(21) Appl. No.: 15/605,157

(22) Filed: May 25, 2017

(30) Foreign Application Priority Data
Jun. 21, 2016 (JP) 2016-122492

(51) Int. Cl. B41J 2/14

(52) U.S. Cl. CPC B41J 2/1433

(57) ABSTRACT

A liquid ejecting head which includes a nozzle forming face onto which a nozzle portion from which liquid is ejected is formed to be open, in which a liquid repellent film including fluorine is formed on the nozzle forming face through a base film interposed therebetween, and a total thickness of the base film is 670 [nm] or less. In addition, a signal intensity of a molecular weight 301 in the liquid repellent film obtained by using a time-of-flight secondary ion mass analysis method is 0.00005 or more and 0.00020 or less, and is 0.00005 or more and 0.00015 or less, preferably.

### BACKGROUND

### 1. Technical Field

The present invention relates to a liquid ejecting head which is mounted on an ink jet recording apparatus, or the like, for example, and a liquid ejecting apparatus, and in particular, a liquid ejecting head which includes a nozzle forming face onto which a nozzle portion is formed to be open, and a liquid ejecting apparatus.

### 2. Related Art

As a liquid ejecting head which causes liquid in a pressure chamber to be ejected (discharged) as liquid droplets from a nozzle by causing a pressure change in the liquid, for example, there is an ink jet recording head (hereinafter, simply referred to as recording head) which is used in an image recording apparatus such as ink jet recording apparatus (hereinafter, simply referred to as printer), a coloring material ejecting head which is used when manufacturing a color filter of a liquid crystal display, or the like, an electrode material ejecting head which is used when forming an electrode of an organic electroluminescence (EL) display, a surface light emission display (FED), or the like, and a bio-organic material ejecting head which is used when manufacturing biochip (biochemical element), or the like. In addition, the recording head for the image recording device ejects liquid-type ink, and the coloring material ejecting head for a display manufacturing device ejects a solution of each coloring material of R (red), G (green), and B (blue). The electrode material ejecting head for the electrode forming device ejects a liquid-type electrode material, and the bio-organic material ejecting head for the chip manufacturing device ejects a solution of a bio-organic material as a type of liquid.

Meanwhile, in a liquid ejecting apparatus on which a liquid ejecting head is mounted, there is a case in which cleaning processing in which thickened liquid or bubbles are forcibly discharged from a nozzle portion of the liquid ejecting head is performed (for example, refer to JP-A-2012-116001 and JP-A-2014-124874). More specifically, thickened liquid, bubbles, or the like, in the inside of a liquid ejecting head is discharged from a nozzle portion by causing the inside of a cap to be in a negative pressure state using a suctioning unit, in a state in which the cap is caused to be in contact with a nozzle forming face onto which the nozzle portion of the liquid ejecting head is formed to be open. Since much liquid is discharged into the cap at once in such cleaning processing, liquid can be easily attached to the nozzle forming face due to spray or rebounding. For this reason, wiping processing in which the nozzle forming face is wiped, using a wiping member is also performed after the cleaning processing. In addition, in the above described liquid ejecting head, a liquid repellent film is formed on the nozzle forming face in order to improve a wiping property, or the like, of liquid which is attached to the nozzle forming face in the wiping processing, and it is possible to improve a liquid repellent property on the nozzle forming face in this manner.

FIGS. 9 to 12 are diagrams for describing cleaning processing in a configuration in the related art. As illustrated in FIG. 9, liquid discharged from a nozzle portion 55 is attached to a nozzle forming face 54, and spreads during the cleaning processing. The above described liquid repellent film 56 is formed on the nozzle forming face 54, and fluorine included in the liquid repellent film 56 is located on the negative polarity side in charging series. For this reason, the liquid repellent film 56 including fluorine is easily charged so as to have a negative polarity due to a contact or friction with liquid. Since a negative pressure state in an internal flow path of the liquid ejecting head is maintained to some degree when cleaning processing is finished, and suctioning using a suctioning unit is stopped, liquid attached to the nozzle forming face 54 is sucked into the flow path from the nozzle portion 55, as illustrated in FIG. 10 (direction denoted by arrow in FIG. 10). At this time, since the liquid attached to the nozzle forming face 54 is sucked into the flow path while being in contact with the liquid repellent film 56, a portion which is in contact with the liquid in the liquid repellent film 56 is negatively charged (−) due to frictional charging with liquid, as illustrated in FIG. 11. When the liquid is ejected as liquid droplets Id from the nozzle portion 55 in this state, as illustrated in FIG. 12, the liquid droplets Id are charged so as to have a positive polarity (+) which is opposite to a charged polarity (negative polarity) of the portion due to electrostatic induction which is caused by the charged portion. For this reason, in a case in which a landing target of liquid is positively charged, there has been a problem in that fine mist which is generated along with ejecting of the liquid is easily attached to the nozzle forming face 54 of the liquid ejecting head. In particular, when a recording medium, or the like, as a landing target of liquid is charged so as to have the same potential as that of the ejected liquid, the recording medium and the liquid resist to each other, and due to this, attaching of liquid to the nozzle forming face 54 occurs more easily. Such a problem becomes more remarkable, since ejected liquid is not easily discharged when a conductivity thereof is lower than that of water (tap water: 1.0×10⁻²[S/m]).

### SUMMARY

An advantage of some aspects of the invention is to provide a liquid ejecting head which can suppress charging of liquid which is ejected from a nozzle portion, and a liquid ejecting apparatus.

According to an aspect of the invention, there is provided a liquid ejecting head which includes a nozzle forming face onto which a nozzle portion from which liquid is ejected is formed to be open, in which a liquid repellent film including fluorine is formed on the nozzle forming face through a base film interposed therebetween, and a total thickness of the base film is 670 [nm] or less.

According to the aspect, it is possible to suppress charging of the nozzle forming face (liquid repellent film) due to a contact with liquid while securing a necessary liquid repellent property. For this reason, charging of liquid which is ejected from the nozzle portion can be suppressed. In this manner, it is possible to suppress a defect which is caused by charging of the liquid, for example, attaching of mist which is generated along with ejecting of liquid to the nozzle forming face or constituent components in a liquid ejecting apparatus.

In the aspect, it is preferable to adopt a configuration in which a signal intensity of a molecular weight 301 in the liquid repellent film obtained by using a time-of-flight secondary ion mass analysis method is 0.00005 or more and 0.00020 or less.

According to the configuration, the liquid repellent film on the nozzle forming face becomes not easy to be charged by regulating content of fluorine in the liquid repellent film so that the signal intensity of the molecular weight 301 using the time-of-flight secondary ion mass analysis method becomes 0.00005 or more and 0.00020 or less, and in this manner, it is possible to further reduce charging of liquid.

In the aspect, it is preferable that the signal intensity be 0.00005 or more and 0.00015 or less.

According to the configuration, the liquid repellent film on the nozzle forming face becomes not easy to be charged, and in this manner, it is possible to further reliably reduce charging of liquid.

In the aspect, it is preferable to configure the base film using at least one or more of a silicon oxide film, a tantalum oxide film, and a plasma polymerized film of a silicon material.

According to the configuration, it is possible to improve an adhesive property of the liquid repellent film with respect to the nozzle forming face, by configuring the base film using at least one or more of the silicon oxide film, the tantalum oxide film, and the plasma polymerized film of the silicon material.

According to another aspect of the invention, there is provided a liquid ejecting apparatus which includes the liquid ejecting head in any one of the aspects.

According to the aspect of the invention, since charging of liquid ejected from a nozzle portion of a liquid ejecting head is suppressed, it is possible to suppress a defect which is caused by charging of liquid, and as a result, reliability as a liquid ejecting apparatus is improved.

### BRIEF DESCRIPTION OF THE DRAWINGS

The invention will be described with reference to the accompanying drawings, wherein like numbers reference like elements.

FIG. 1 is a plan view which describes a configuration of a liquid ejecting apparatus (printer).

FIG. 2 is a sectional view of a liquid ejecting head (recording head).

FIG. 3 is a base view of the liquid ejecting head.

FIG. 4 is a sectional view at the periphery of a nozzle portion.

FIG. 5 is a graph for describing a relationship among a signal intensity of a molecular weight 301 in a liquid repellent film, an ink potential based on charging of ink, an attaching amount of mist on the nozzle forming face, and a printing quality.

FIG. 6 is a schematic view which describes a configuration for measuring an ink potential.

FIG. 7 is a table which denotes a relationship among a layer configuration of a base film, a total thickness, and the ink potential.

FIG. 8 is a graph which denotes a relationship between the total thickness of the base film and the ink potential.

FIG. 9 is a schematic view which describes cleaning processing in a configuration in the related art.

FIG. 10 is a schematic view which describes cleaning processing in the configuration in the related art.

FIG. 11 is a schematic view which describes cleaning processing in the configuration in the related art.

FIG. 12 is a schematic view which describes cleaning processing in the configuration in the related art.

### DESCRIPTION OF EXEMPLARY EMBODIMENTS

Hereinafter, embodiments for executing the invention will be described with reference to accompanying drawings. In the embodiments which will be described below, there are various limitations as preferable specific examples of the invention; however, the scope of the invention is not limited to these forms as long as there are no descriptions for limiting the invention, particularly in the following descriptions. In addition, in the following descriptions, an ink jet recording apparatus (hereinafter, referred to as printer) will be exemplified as a liquid ejecting apparatus in the invention.

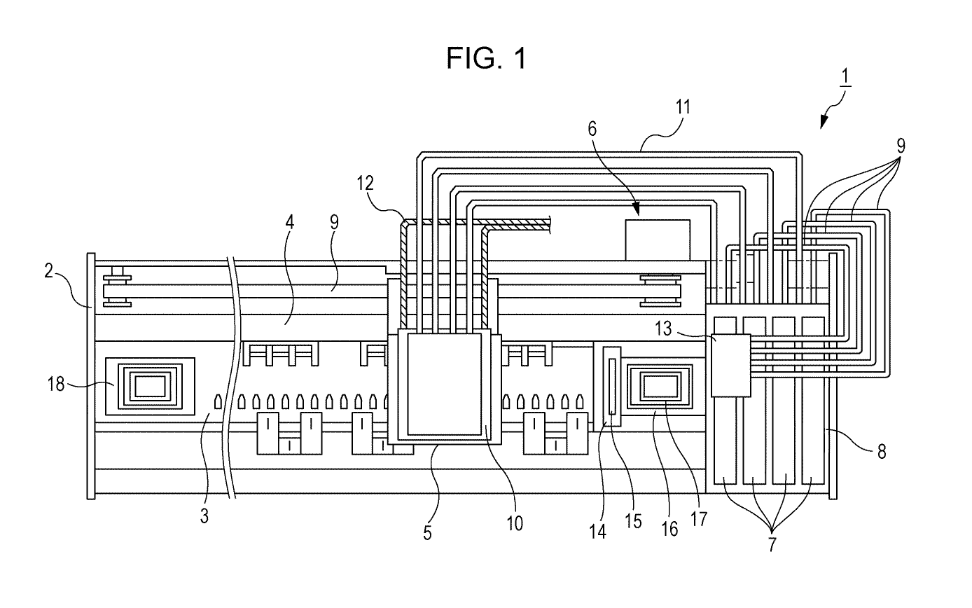

FIG. 1 is a plan view which illustrates a configuration of a printer 1 on which a recording head 10 as a type of a liquid ejecting head in the invention is mounted. The printer 1 is provided with a frame 2, and a platen 3 which is provided in the frame 2, and in which a recording medium (a type of landing target of liquid) such as a recording sheet, cloth, or a resin sheet is transported onto the platen 3 using a sheet feeding roller which rotates due to driving of a sheet feeding motor (both are not illustrated). A guide rod 4 is installed in parallel to the platen 3 in the frame 2, and a carriage 5 which accommodates the recording head 10 is supported by the guide rod 4 so as to slide. The carriage 5 is configured so as to reciprocate in a main scanning direction which is orthogonal to a transport direction of the recording medium along the guide rod 4 due to driving of a carriage moving mechanism 6. The printer 1 forms (records or prints) a landing pattern such as characters or images by causing ink (a type of liquid in the invention) to be ejected from a nozzle portion 42, which will be described later, of the recording head 10 while causing the carriage 5 to move in the main scanning direction relatively to the recording medium which is mounted on the platen 3, and causing the ink to land on the recording medium.

A cartridge holder 8 on which an ink cartridge 7 which stores ink is detachably mounted is provided on the frame 2 side. According to the embodiment, four ink cartridges 7 in total are mounted on the cartridge holder 8. As ink, for example, it is possible to use ink of various compositions, which is well known, such as water-based dye ink or pigment ink, organic solvent-based (eco-solvent-based) ink of which weather resistance is improved compared to the water-based ink, or photocurable ink which is cured by being irradiated with uv light. The ink cartridge 7 in the embodiment is connected to an air pump 13 through an air tube 9, and air from the air pump 13 is supplied into each of the ink cartridges 7. In addition, ink is supplied (sent in pressurizing manner) to the recording head 10 side through an ink supply tube 11 when the inside of the ink cartridges 7 is pressurized due to the air. The ink supply tube 11 is a hollow member with flexibility which is made of, for example, elastomer with ink resistance, or a synthetic resin of fluorine, or the like, and an ink flow path which corresponds to each of the ink cartridges 7 is formed inside the ink supply tube 11. In addition, a flexible flat cable (FFC) 12 for transmitting a driving signal, or the like, to the recording head 10 side from a control unit (not illustrated) on a printer main body side is provided between the main body side of the printer 1 and the recording head 10 side.

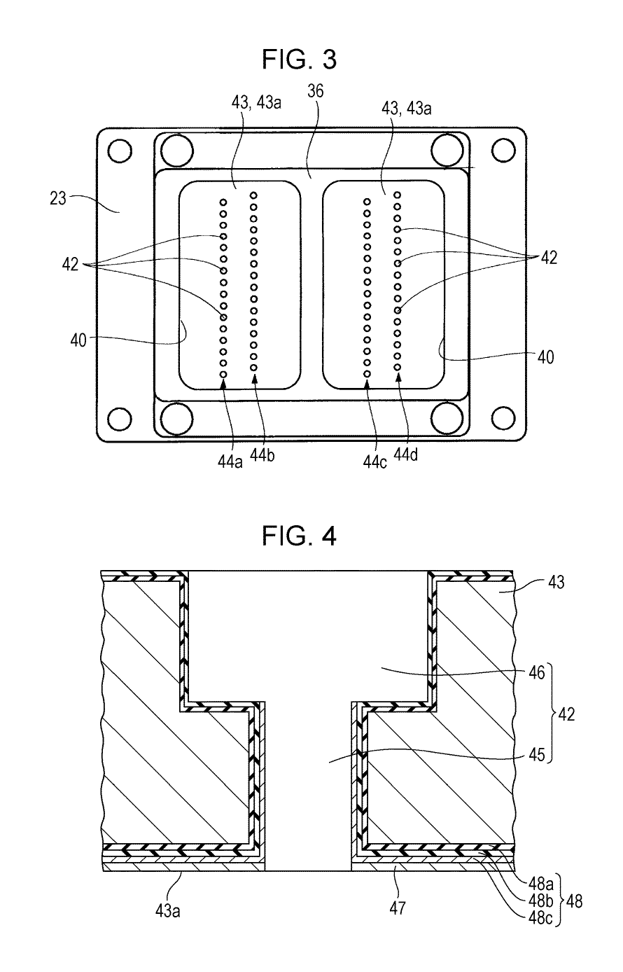

A wiping mechanism 14 which wipes a nozzle forming face 43a (face which faces platen 3) (refer to FIG. 3, or the like) of a nozzle plate 43 of the recording head 10 which is mounted on the carriage 5 is provided at a home position as a non-recording region of the printer 1. The wiping mechanism 14 includes a wiper blade 15 (a type of wiping member), and the wiper blade 15 is configured of an elastic member such as rubber or elastomer. In the wiping mechanism 14, the wiper blade 15 is disposed at a position at which the wiper blade can be in contact with the nozzle forming face 43a of the recording head 10 when a tip end portion of the wiper blade performs wiping. In addition, the nozzle forming face 43a is wiped by the wiper blade 15 when the tip end portion of the wiper blade 15 comes into contact with the nozzle forming face 43a along with passing through of the recording head 10, and a relative movement of both is performed.

A capping mechanism 16 is provided at the home position, or vicinity thereof, by being adjacent to the wiping mechanism 14. The capping mechanism 16 includes a tray-shaped cap 17 which can be in contact with the nozzle forming face 43a of the recording head 10. In the capping mechanism 16, a space in the cap 17 functions as a sealing vacant portion, and is configured so as to be in close contact with the nozzle forming face 43a in a state in which a nozzle portion 42 of the recording head 10 is caused to face the inside of the sealing vacant portion. In addition, a pump unit (not illustrated) (a type of suctioning unit) is connected to the capping mechanism 16, and it is possible to set the inside of the sealing vacant portion to a negative pressure state using an operation of the pump unit. When the pump unit is operated in a state of being in close contact with the nozzle forming face 43a, and the inside of the sealing vacant portion (closed space) is set to the negative pressure state, ink or bubbles in the recording head 10 are suctioned from the nozzle portion 42, and are discharged to the inside of the sealing vacant portion of the cap 17. The ink which is discharged to the inside of the sealing vacant portion is discharged to a drain tank (not illustrated) through a drain tube which is connected to the cap 17. A series of processes using the capping mechanism 16 is suctioning-type cleaning processing (hereinafter, simply referred to as cleaning processing). It is also possible for the printer 1 according to the embodiment to perform pressurizing-type cleaning processing in which an ejecting capability of the nozzle portion 42 is recovered by discharging thickened ink, or the like, from the nozzle portion 42, by pressurizing the inside of the flow path of the recording head 10, by pressurizing a supply flow path of ink on the upstream side (ink cartridge 7 side) of the recording head 10 using the air pump 13, for example.

A flushing box 18 as a flushing region is provided at the other end portion (left side in FIG. 1) in the main scanning direction of the home position by interposing the platen 3. The flushing box 18 receives ink which is ejected at a time of a flushing operation in which ink is forcibly ejected from the nozzle portion 42 of the recording head 10, separately from a printing operation (ejecting operation) with respect to a recording medium. One end of the drain tube (not illustrated) is connected to the flushing box 18, and communicates with the above described drain tank. In addition, a suctioning pump is provided in the middle of the drain tube, and ink in the flushing box 18 is discharged to the drain tank through the drain tube by operating the suctioning pump.

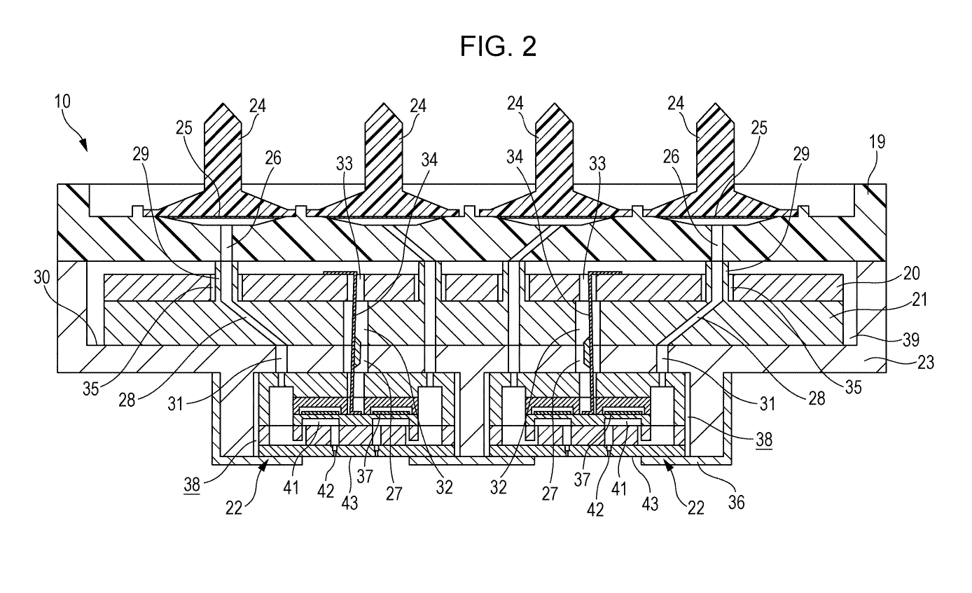

FIG. 2 is a sectional view of the recording head 10 in the embodiment, and FIG. 3 is a base view of the recording head 10. The recording head 10 in the embodiment is provided with an ink introducing member 19, a relay board 20, an intermediate flow path member 21, a head unit 22, a holder 23, and the like, by stacking thereof. Hereinafter, a stacking direction of each member will be described as a vertical direction for convenience.

A plurality of ink introducing needles 24 are erected on a top face of the ink introducing member 19 by interposing filters 25 therebetween. The ink introducing needles 24 are provided in each type (color) of ink. Both of the ink introducing member 19 and the ink introducing needle 24 are made of a synthetic resin. The filter 25 is a member for filtering ink introduced from the ink introducing needle 24, and foreign substances or bubbles in the ink are caught by the filter 25. According to the embodiment, a sub tank (not illustrated) is mounted on the top face side of the ink introducing member 19, and the ink introducing needle 24 is inserted into the sub tank. In addition, ink in the ink cartridge 7 is temporarily introduced to the sub tank through the ink supply tube 11, and is introduced to an internal flow path of the ink introducing needle 24 through an introducing hole (not illustrated) which is provided at a tip end portion of the ink introducing needle 24 from the sub tank. When the ink is introduced from the ink introducing needle 24, the ink passes through the supply flow path 26 by passing through the filter 25, and is supplied to the intermediate flow path member 21 which is disposed under the ink introducing member 19 through a flow path connecting portion 29. In the ink introducing member 19 in the embodiment, the needle-shaped ink introducing needle 24 is adopted; however, it is not limited to this. For example, it is also possible to adopt a so-called foam-system configuration in which a porous member such as non-woven fabric or sponge is provided at an ink introducing portion of the ink introducing member 19, the same porous member is also provided at an ink deriving portion of an ink storage member such as the ink cartridge or the sub tank, both of the porous members come into contact, and delivering of ink is performed, using a capillary phenomenon.

The intermediate flow path member 21 is a substrate on which an intermediate flow path 28 which guides ink introduced from the ink introducing needle 24 to the head unit 22 side. A cylindrical-shaped flow path connecting portion 29 is provided in a protruding manner at a peripheral edge of an opening on an entrance side of the intermediate flow path 28, on a top face of the intermediate flow path member 21. A height of the flow path connecting portion 29 (protruding length from top face of intermediate flow path member 21) is set to a thickness of the relay board 20 or more which is disposed between the ink introducing member 19 and the intermediate flow path member 21. In addition, the flow path connecting portion 29 receives ink from the ink introducing member 19 by communicating with the supply flow path 26 of the ink introducing member 19, and introduces the ink to the intermediate flow path 28 side. The intermediate flow path 28 opens to a lower face of the intermediate flow path member 21, and communicates with a communicating flow path 31 which is formed to be open to a partitioning board 30 of the holder 23. In addition, in the intermediate flow path member 21, a wiring opening portion 32 which penetrates a plate thickness direction is formed to be open at a position far from the intermediate flow path 28. The wiring opening portion 32 is a vacant portion which communicates with a wiring insertion port 33 of the relay board 20 which will be described later, communicates with a wiring penetrating port 27 which is formed in the partitioning board 30 of the holder 23, and into which a flexible board 34 is inserted.

The relay board 20 which is disposed between the ink introducing member 19 and the intermediate flow path member 21 is a printed board on which a wiring pattern, or the like, for supplying a driving signal to a piezoelectric element 37 on the head unit 22 side through the flexible board 34, by receiving the driving signal, ejection data (raster data), or the like, from a main body side of the printer through the FFC 12 is formed. A board terminal which is connected to the flexible board 34 is formed on a top face of the relay board 20 (face on side opposite to lower face on head unit 22 side), and in which a connector to which the FFC 12 from the printer main body side is connected, or electronic components, and the like, other than that are mounted (none of those are illustrated).

In the relay board 20, an escape hole 35 into which the flow path connecting portion 29 is inserted is formed to be open at a position corresponding to the flow path connecting portion 29 of the intermediate flow path member 21. The escape hole 35 is a through hole which is smaller than an outer diameter of the flow path connecting portion 29. In addition, the wiring insertion port 33 which penetrates the board thickness direction is formed at a position in the relay board 20 which is adjacent to the board terminal along an aligning direction of the board terminal. The wiring insertion port 33 is a hole into which the other end side of the flexible board 34 of which one end is connected to an element terminal of the piezoelectric element 37 is inserted. Internal sizes of the wiring insertion port 33 in the longitudinal direction and the transverse direction in the embodiment are set to sizes through which the flexible board 34 can be inserted without a problem.

A plurality of accommodating vacant portions 38 as spaces which can accommodate the head unit 22 are partitioned inside the holder 23. A lower face side (side faces recording medium in the middle of printing operation in printer 1) of the accommodating vacant portion 38 is open, and the head unit 22 which is bonded to a fixing plate 36 is accommodated from the opening. The fixing plate 36 is configured of a metallic plate member such as stainless steel. As illustrated in FIG. 3, an opening portion 40 for exposing a region in which the nozzle portion 42 in the nozzle plate 43 of each of the head units 22 is formed is formed to be open in the fixing plate 36. When a base of each of the head units 22 is bonded to the fixing plate 36, a height direction (position in direction orthogonal to nozzle plate 43) of the head unit 22 is regulated, and the nozzle portion 42 of the nozzle plate 43 is exposed to the opening portion 40.

A board mounting unit 39 on which the intermediate flow path member 21 and the relay board 20 are disposed is provided on a top face side in the holder 23 which is higher than the accommodating vacant portion 38. The board mounting unit 39 and the accommodating vacant portion 38 are partitioned by the partitioning board 30, and the intermediate flow path member 21 is mounted on a top face of the partitioning board 30. The communicating flow path 31 and the wiring penetrating port 27 are formed in the partitioning board 30 in a state of penetrating the board thickness direction. When the head unit 22 is accommodated in a state of being positioned in the accommodating vacant portion 38, an ink flow path including the nozzle portion 42 of the head unit 22 and a pressure chamber 41 communicates with the communicating flow path 31. In this manner, ink introduced through the ink introducing needle 24 is filtered in a filter 25, and is filled in the ink flow path (a type of liquid flow path) which reaches the nozzle portion 42 of the head unit 22 through the supply flow path 26, the intermediate flow path 28, and the communicating flow path 31 thereafter.

The head unit 22 in the embodiment is provided with the nozzle plate 43 onto which the nozzle portion 42 is formed to be open, the pressure chamber 41 which communicates with the nozzle portion 42, the piezoelectric element 37 as a driving element which causes a pressure change in ink in the pressure chamber 41, and the like. The nozzle plate 43 is a plate member on which a plurality of the nozzle portions 42 are formed to be open in column. In the embodiment, a nozzle column 44 is configured of the plurality of nozzle portions 42 which are provided in column at a predetermined pitch. The pressure chamber 41 and the piezoelectric element 37 are provided in each nozzle portion 42. A terminal on one end side of the flexible board 34 to which the other end side of the relay board 20 is connected is connected to an electrode terminal (not illustrated) of the piezoelectric element 37. When a driving signal (driving voltage) is applied to the piezoelectric element 37 through the relay board 20 and the flexible board 34, a piezoelectric active portion of the piezoelectric element 37 is deformed in a flexural manner according to a change in an applied voltage, and a flexible face which partitions one face of the pressure chamber 41 displaces on a side which is close to the nozzle portion 42 or in a direction far from the nozzle portion 42. In this manner, a pressure change is caused in ink in the pressure chamber 41, and ink is ejected from the nozzle portion 42 using the pressure change. A configuration of the recording head 10 is not limited to the exemplified configuration, and for example, it is possible to adopt a recording head (liquid ejecting head) of various configurations in which another actuator such as a heating element or an electrostatic actuator is adopted, as the actuator for ejecting ink.

Subsequently, the nozzle plate 43 will be described in detail. The nozzle plate 43 is a member in which the plurality of nozzle portions 42 are formed to be in column at a predetermined pitch. As a material of the nozzle plate 43, a silicon substrate or a metallic plate such as stainless steel is used. In the embodiment, the nozzle column 44 is configured of the plurality of nozzle portions 42 which are aligned in a direction corresponding to a transport direction of a recording medium, and nozzle columns 44 of two lines are respectively formed in the nozzle plate 43 of each head unit 22. For this reason, in the recording head 10 according to the embodiment, nozzle columns 44a to 44d of four lines in total are provided in line along the main scanning direction of the recording head 10, as illustrated in FIG. 3. In addition, a face which faces a recording medium on the platen 3 as a face on a side on which ink of the nozzle plate 43 is ejected corresponds to a nozzle forming face of the recording head 10. The nozzle portion 42 means a through hole which is formed to be opened to the nozzle plate 43, and as will be described later, in a configuration in which a liquid repellent film 47 or a base film 48 is included on the nozzle forming face, a hole which penetrates these films is also included in the nozzle portion 42. That is, a range from an opening on the nozzle forming face 43a side of the through hole which is formed on the nozzle plate 43 including the liquid repellent film 47 or the base film 48 to an opening on a face on the opposite side (pressure chamber 41 side) is set to the nozzle portion 42.

FIG. 4 is a sectional view which goes along a central axis direction (ink ejection direction) of the nozzle portion 42. The higher side in FIG. 4 is the upstream side (pressure chamber 41 side) in the ink ejection direction, and the lower side in the downstream side (platen 3 side) in the ink ejection direction. The nozzle portion 42 in the embodiment exhibits a cylindrical shape of two stages due to a first nozzle portion 45 on the downstream side and a second nozzle portion 46 on the upstream side, and a sectional area of a flow path of the first nozzle portion 45 is set to be smaller than that of the second nozzle portion 46. Both of the first nozzle portion 45 and the second nozzle portion 46 exhibit a perfect circle shape when viewed planarly. Ink is ejected from an opening on a side opposite to the second nozzle portion 46 side of the first nozzle portion 45. Here, the perfect circle shape also includes a perfect circle which is imperfect to some degree, not only the completely perfect circle. In brief, when it can be generally recognized as an approximately perfect circle, visually, it is included in the perfect circle shape. The second nozzle portion 46 may be formed in a tapered shape in which an inner wall face is inclined so that an inner diameter thereof is enlarged from the downstream side (first nozzle portion 45 side) toward the upstream side (pressure chamber 41 side).

The liquid repellent film 47 is formed on the nozzle forming face 43a of the nozzle plate 43 through the base film 48. The base film 48 is provided in order to combine the nozzle plate 43 and the liquid repellent film 47 together by interposing therebetween. The base film 48 in the embodiment is configured of a three-layer structure of a first layer 48a on a base material side of the nozzle plate 43, an intermediate second layer 48b, and a third layer 48c on the liquid repellent film 47 side. The first layer 48a is configured of a silicon oxide film (SiOx: for example, SiO₂), the second layer 48b is configured of tantalum oxide film (TaOx: for example, Ta₂O₅), and the third layer 48c is configured of a plasma polymerization silicone (PPSi) film of a silicon material (polyorganosiloxane including alkyl group), respectively. In addition, the liquid repellent film 47 is formed by being applied with a liquid repellent agent (silane coupling agent) including fluorine. As the liquid repellent agent, a silane compound including a fluoroalkyl group, for example, trifluoro propyl trimethoxysilane is used. The liquid repellent film 47 may be formed, using deposition, spin-coating, or the like, for example, not using coating. Here, the liquid repellent film 47 including fluorine in the charging series is located on the negative polarity side compared to ink. A difference in a rank of the liquid repellent film 47 and a rank of ink in the charging series is larger than a difference between a rank of the base film 48 and a rank of ink, or a difference between a rank of a material of the nozzle plate 43 (silicon or metal) and a rank of ink. Accordingly, the liquid repellent film 47 is easily charged so as to have a negative polarity due to a contact and friction with ink compared to other materials.

The nozzle plate 43 in the embodiment is manufactured in the following procedure. First, the first layer 48a which is formed of silicon oxide is formed by oxidizing the surface of a base material (silicon substrate in embodiment) of the nozzle plate 43 on which the nozzle portion 42 is formed. Since the first layer 48a is formed on the entire surface of the base material of the nozzle plate 43, the first layer is also formed on the inner peripheral face of the nozzle portion 42. A film thickness of the first layer 48a is approximately from several tens [nm] to several hundreds [nm], and is adjusted to 100 [nm] in the embodiment. Subsequently, the second layer 48b formed of tantalum oxide is formed, using an atomic layer depositing method (ALD), for example. Since the second layer 48b is formed on the entire surface of the base material of the nozzle plate 43 by overlapping with the first layer 48a thereon, the second layer is also formed in the inner peripheral face of the nozzle portion 42. A film thickness of the second layer 48b is approximately several tens [nm], and is adjusted to 12.5 [nm] in the embodiment. When the second layer 48b is formed, resistance to alkali or acid is improved. That is, the second layer 48b functions as a protective layer of the nozzle plate 43. Subsequently, the PPSi film is formed by performing plasma polymerization with respect to a silicone material on the second layer 48b using a plasma CVD method, and the third layer 48c is formed by oxidizing the PPSi film, for example. A film thickness of the third layer 48c is approximately several hundreds [nm], and is adjusted to 500 [nm] in the embodiment. Accordingly, a total thickness of the base film 48 in the embodiment becomes 612.5 [nm] which is smaller than 670 [nm]. In this manner, it is possible to suppress charging of the liquid repellent film 47 by adjusting the total film thickness of the base film 48 to 670 [nm] or less (appropriately referred to as first condition) which is a condition in the invention. This will be described later in detail. The base film 48 is configured of three layers of the first layer 48a, the second layer 48b, and the third layer 48c in the embodiment; however, it is not limited to this, and the film may be configured of at least any one or more of the silicon oxide film, the tantalum oxide film, and the PPSi film.

Subsequently, for example, the entire base material of the nozzle plate 43 is immersed in metal alkoxide solution which is formed by mixing a silane coupling agent including a fluoroalkyl group with a solvent, and a molecular film in which metal alkoxide is polymerized on the base film 48 is formed in this manner. Thereafter, the liquid repellent film 47 is formed on the entire surface of the base material of the nozzle plate 43 and the inner peripheral face of the nozzle portion 42 through drying processing, annealing processing, or the like. Since the liquid repellent film 47 is mainly necessary for the nozzle forming face 43a, extra liquid repellent film 47 is removed, subsequently. Specifically, for example, plasma processing is performed from a face (face on pressure chamber 41 side) on the opposite side of the nozzle forming face 43a of the nozzle plate 43, and the liquid repellent film 47 in a portion excluding the nozzle forming face 43a is removed. In addition, there also is a case in which the liquid repellent film 47 partially remains also in the inner periphery of the nozzle portion 42.

Here, as described above, since the liquid repellent film 47 including fluorine is located on the negative polarity side compared to ink in the charging series, the smaller the content of fluorine included in the liquid repellent film 47, it is not easy to charge the liquid repellent film when being in contact with ink. However, when content of fluorine becomes small, since a liquid repellent property also decreases along with this, it is preferable to adjust content of fluorine in the liquid repellent film 47 in a viewpoint of suppressing charging due to a contact with ink, while securing a necessary liquid repellent property. More specifically, it is preferable to adjust content of fluorine (amount of fluorine per unit area) in the liquid repellent film 47 so that a signal intensity of the molecular weight 301 (C₅F₁₁O₂) when measuring an area of 100 [μm]×100 [μm] in the liquid repellent film 47 using the time-of-flight secondary ion mass analysis method (TOF-SIMS) is in a range of 0.00005 or more and 0.00020 or less (appropriately referred to as second condition) as the condition in the invention. It is more preferable when the signal intensity is in a range of 0.00005 or more and 0.00015 or less (appropriately referred to as third condition). In this manner, in the invention, content of fluorine included in the liquid repellent film 47 is indirectly regulated by the signal intensity of the molecular weight 301.

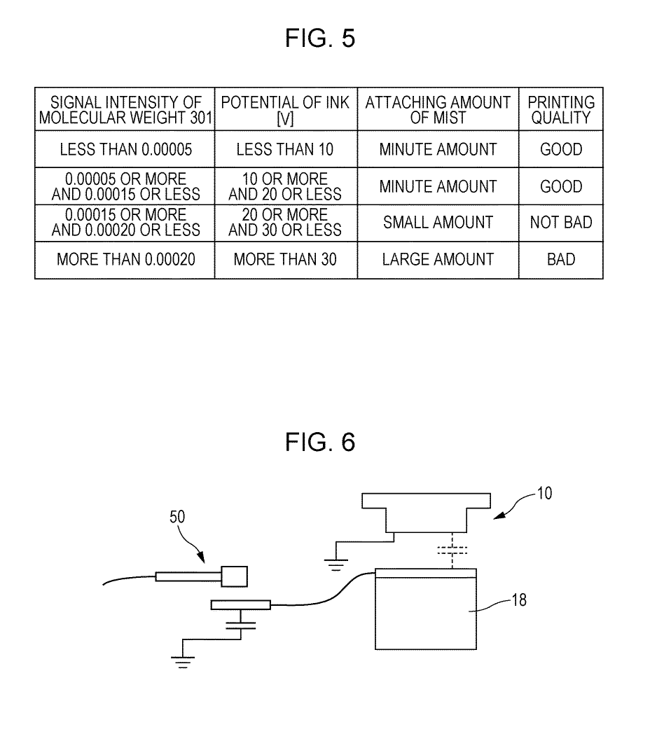

FIG. 5 is a table which describes a relationship among a signal intensity of the molecular weight 301 in the liquid repellent film 47, an ink potential based on charging of ink [V], an amount of mist which is attached to the nozzle forming face 43a, and a printing quality. FIG. 6 is a schematic view which describes a configuration of measuring an ink potential. The ink potential [V] in FIG. 5 denotes a range of values when measuring a charged amount of ink which is landed on the flushing box 18, and is collected, when ink is caused to be ejected 10,000 times in total toward the flushing box 18 from the entire nozzle portions 42 of the recording head 10 (360 nozzles×the number of nozzle columns (types of ink)), respectively, using the surface potentiometer 50 (manufactured by Trek Japan Co., Ltd.) after the above described cleaning processing. In addition, the attaching amount of mist is an amount of mist attached to the nozzle forming face 43a which is caused by charging of the liquid repellent film 47 and ink, and in which an attaching amount with almost no concern (for example, recording medium is contaminated due to dropping of drop which is formed of accumulated mist, ejecting of ink becomes unstable due to bending of flying direction of ink ejected from nozzle portion 42, or the like) of a defect due to the mist is set to a “minute amount”, an attaching amount which is larger than the “minute amount”; however, there is no concern of a defect, immediately, is set to a “small amount”, and an attaching amount in which there is a possibility of an immediate occurrence of a defect due to mist is set to a “large amount”. In addition, the “printing quality” denotes a degree of an influence to an image quality caused by unstable ejecting of ink due to mist attached to the nozzle forming face 43a in a case in which an image, or the like, is printed (recorded) on a recording medium, “good” denotes that there is almost no influence to an image quality, which is caused by mist, and “bad” denotes a degree in which there is an influence to an image quality, and deterioration of an image quality is visually recognized. In addition, relating to the recording head 10 as a measuring target, a configuration of the base film 48 or a film thickness is set to be the same, and a recording head in which only content of fluorine included in the liquid repellent film 47 is different is set to a target.

As illustrated in FIG. 5, it is understood that ink ejected from the nozzle portion 42 is not easily charged, since charging of the liquid repellent film 47 due to friction with ink is suppressed, when the signal intensity of the molecular weight 301 using TOF-SIMS is small, that is, when the content of fluorine included in the liquid repellent film 47 is small. That is, when the signal intensity of the molecular weight 301 is less than 0.00005, a potential of ink [V] immediately after the cleaning processing is less than 10 [V], and an amount of mist attached to the nozzle forming face 43a becomes a “minute amount”. Due to this, a printing quality becomes “good”. However, in a configuration in which content of fluorine in the liquid repellent film 47 is too small, or fluorine is not included at all, there is a case in which it is not possible to obtain a necessary liquid repellent performance on the nozzle forming face 43a. For this reason, when a signal intensity of the molecular weight 301 is in a range of 0.00005 or more and 0.00020 or less which is the second condition in the invention, an ink repellent property of the nozzle forming face 43a is secured, a potential of ink becomes at least 30 [V] or less, an attaching amount of mist becomes “small”, and a printing quality becomes “not bad”. In addition, when a signal intensity of the molecular weight 301 is in a range of 0.00005 or more and 0.00015 or less which is the third condition, it is more preferable to suppress a defect due to mist of ink, while securing a liquid repellent performance which is necessary for the liquid repellent film 47, since a potential of ink becomes 10 [V] or more and 20 [V] or less, an attaching amount of mist becomes “minute”, and a printing quality becomes “good”. Meanwhile, when a signal intensity exceeds 0.00020, an ink potential exceeds 30 [V], and as a result, an attaching amount of mist becomes “large”, and a printing quality becomes “bad”.

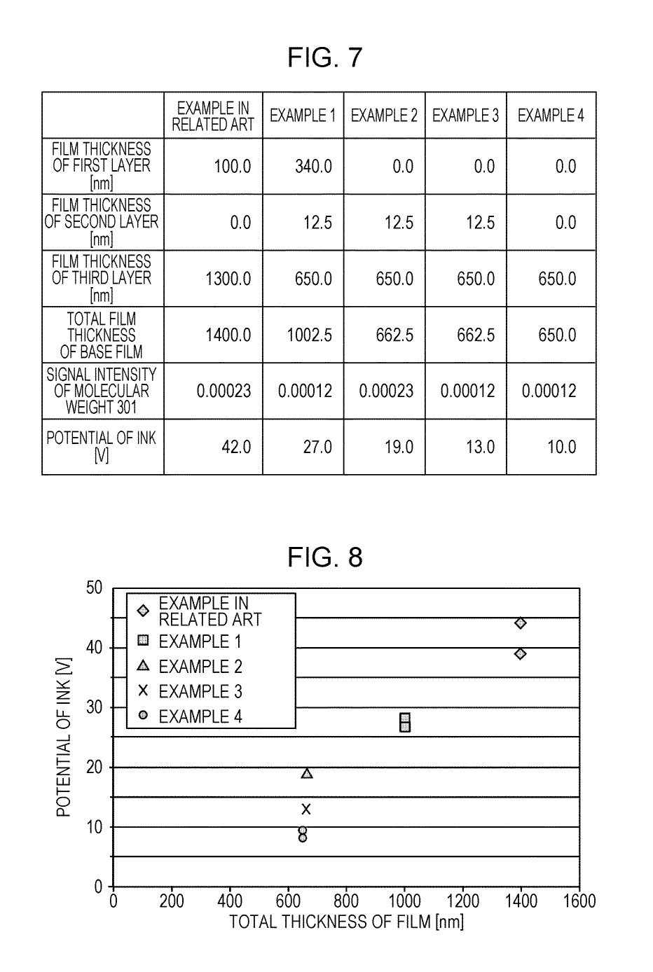

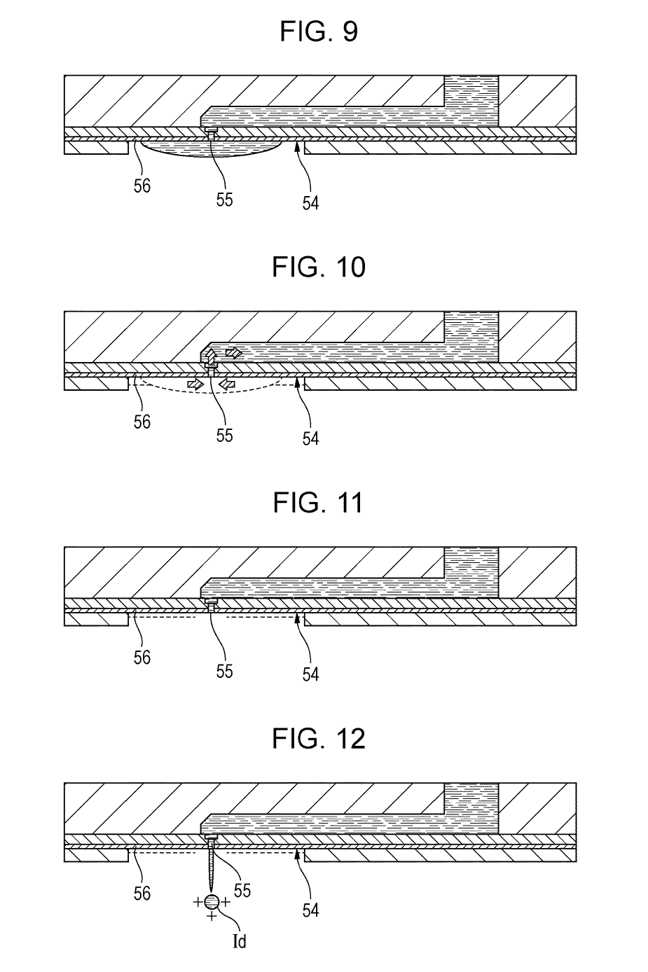

FIG. 7 is a table which denotes a relationship between a layer configuration, and a film thickness (total thickness) of a plurality of types of recording heads 10 in which a layer configuration (first layer, second layer, third layer, or combination of these) of the base film 48 is different and a potential of ink [V]. FIG. 8 is a graph which denotes a relationship between a total thickness of the base film 48 and a potential of ink [V] immediately after cleaning processing. In addition, a measuring method of the potential of ink [V] is the same as above. When decreasing content of fluorine included in the liquid repellent film 47 as described above, it is possible to suppress charging of ink, and it is possible to further suppress charging of ink by making the thickness of the base film 48 smaller. A recording head in an example in the related art has a configuration in which there is no second layer, a film thickness of the first layer is 100 [nm], a film thickness of the third layer is 1300 [nm], a total thickness of the base film is 1400 [nm] which is the thickest film in FIGS. 7 and 8, and does not satisfy 670 [nm] or less which is the first condition in the invention. In addition, the recording head has a configuration in which a signal intensity of the molecular weight 301 is 0.00023 which is the largest signal intensity in the table in FIG. 7, and does not satisfy the second and third conditions in the invention. That is, the recording head in the example in the related art does not satisfy any of the conditions in the invention. In the recording head in the example in the related art, a potential of ink [V] is 42 [V] (39 [V] or 40 [V] in FIG. 8), and it is easiest for ink to be charged. For this reason, mist is easily attached to the nozzle forming face, and a defect due to the mist easily occurs.

In a recording head 10 in example 1, a base film 48 is configured of a first layer 48a (340 [nm]), a second layer 48b (12.5 [nm]), and a third layer 48c (650 [nm]), a total thickness of the base film 48 is 1002.5 [nm], and does not satisfy the first condition (670 [nm]) in the invention, though it is smaller than that in the example in the related art. Meanwhile, a signal intensity of the molecular weight 301 is 0.00012, is in the range of 0.00005 or more and 0.00020 or less which is the second condition in the invention, and is in the range of 0.00005 or more and 0.00015 or less which is the third condition. In the configuration in example 1, charging of ink is suppressed, since a potential of ink [V] is 27 [V] (27 [V] or 28 [V] in FIG. 8), content of fluorine included in the liquid repellent film 47 is smaller than that in the example in the related art, and the second and third conditions are satisfied, as described above in FIG. 5. In a configuration of a recording head 10 in example 2, a base film 48 is configured of a second layer 48b (12.5 [nm]) and a third layer 48c (650 [nm]), a total thickness of the base film 48 is 662.5 [nm], and the first condition in the invention is satisfied. Meanwhile, a signal intensity of the molecular weight 301 is 0.00023 which is the same as that in the example in the related art, and the second and third conditions in the invention are not satisfied. It is understood that charging of ink is effectively suppressed in the configuration in example 2, since the first condition is satisfied, even though a potential of ink [V] is 19 [V], and the second and third conditions are not satisfied. That is, in the configuration in example 2, it is possible to suppress charging of ink ejected from the nozzle portion 42 while securing a sufficient liquid repellent performance by having the same content of fluorine included in the liquid repellent film 47 as that in the example in the related art.

Both of the configurations of recording heads 10 in example 3 and example 4 satisfy all of the first, second and third conditions in the invention. That is, in the configuration in example 3, a signal intensity of the molecular weight 301 is 0.00012, is in the range of 0.00005 or more and 0.00020 or less which is the second condition in the invention, and is in the range of 0.00005 or more and 0.00015 or less which is the third condition. In addition, the base film 48 is configured of a second layer 48b (12.5 [nm]) and a third layer 48c (650 [nm]), a total thickness of the base film 48 is 662.5 [nm], and the first condition in the invention is satisfied. In the configuration in example 3, a potential of ink [V] is 13 [V] which is lower than that in example 2. In a configuration in example 4, a signal intensity of the molecular weight 301 is 0.00012, the second and third conditions in the invention are satisfied, a base film 48 is configured only of a third layer 48c (650 [nm]), a total thickness of the base film 48 is 650 [nm], is the thinnest film in the exemplified recording heads, and accordingly, the first condition is satisfied. In the configuration in example 4, a potential of ink [V] is 10 [V] or less, and is set to the lowest value. That is, the configurations in examples 3 and 4 are most preferable in a case of attaching more importance to suppressing charging of ink.

As illustrated in FIG. 8, it is understood that there is a correlation between a total thickness of the base film 48 and a potential of ink [V] regardless of a layer configuration of the base film 48, and the smaller the total thickness of the base film 48, charging of ink is suppressed. That is, the liquid repellent film 47 gets close to the surface of the base material of the nozzle plate 43 which is made of silicon or metal by making the thickness of the base film 48 small. In this manner, it is possible to set the liquid repellent film 47 to be not easily charged, and as a result, it is possible to suppress charging of ink ejected from the nozzle portion 42, since charges easily escape to the base material side of the nozzle plate 43, even though the liquid repellent film 47 is charged. Accordingly, it is possible to give the nozzle forming face 43a a liquid repellent property which is necessary when considering a wiping property, or the like, of ink using a wiping member while suppressing charging of ink, by setting the total thickness of the base film 48 to be small. As denoted by the graph in FIG. 8, when satisfying 670 [nm] or less which is the first condition, it is possible to suppress a potential of ink [V] immediately after cleaning processing to less than 20 [V]. However, it is based upon the premise that the base film 48 is configured of at least any one or more of a silicon oxide film, a tantalum oxide film, and a PPSi film. For this reason, a lower limit of the total thickness of the base film 48 is set to be larger than zero, at the least.

In this manner, it is possible to suppress charging of the nozzle forming face 43a due to a contact with ink while securing a necessary liquid repellent property, by regulating content of fluorine (signal intensity of molecular weight 301 when performing measuring, using TOF-SIMS) and a total thickness of the base film 48. Due to this, it is possible to prevent ink from being positively charged due to electrostatic induction when the ink is ejected from the nozzle portion 42. For this reason, also in a case in which printing or recording (operation of ejecting ink) is performed with respect to a recording medium which is positively charged, for example, it is possible to relieve a situation in which the recording medium and ink resist to each other, and mist of the ink is attached to the nozzle forming face 43a, or to another constituent component in the printer 1. As a result, reliability of the printer 1 improves. In particular, it is more effective when adopting a configuration in which ink with conductivity of 1.0×10⁻³ [S/m] or less (that is, ink which is not easily discharged when being charged) is ejected. As such ink, for example, there is organic solvent-based (eco-solvent-based) ink of which weather resistance is increased, photo-curable ink which is cured when being irradiated with uv light, or the like.

Here, a configuration in which conductivity of a plurality of types of ink which is treated by the recording head 10 is different will be described. As described above, conductivity of organic solvent-based ink or photocurable ink is lower than that of water-based dye ink or water-based pigment ink, and for this reason, the latter is easily charged. As illustrated in FIG. 3, in the recording head 10 according to the embodiment, ink with low conductivity is assigned for the first nozzle column 44a and the fourth nozzle column 44d which are located at end portions in the main scanning direction, and ink with high conductivity is assigned for the second nozzle column 44b and the third nozzle column 44c which are located on the center portion side in the main scanning direction, among the nozzle columns 44a to 44d which are aligned in the main scanning direction. In this manner, in a so-called serial type printer 1 in which ink is ejected from the nozzle portion 42 while a recording medium and the recording head 10 relatively move, even when the ink is charged when being ejected, it is possible to make mist generated along with this not easy to be attached to the nozzle forming face 43a by assigning ink with low conductivity, and which is easily charged to the nozzle column 44 which is located on the end portion side among the nozzle columns 44 which are aligned in the main scanning direction as the relative movement direction.

In the above described embodiment, the so-called serial type printer 1 in which ejecting of ink is performed while moving the recording head 10 relatively to a recording medium with respect to a width direction of the recording medium has been exemplified; however, it is not limited to this. For example, it is also possible to apply the invention to a so-called line type printer in which a whole length of a nozzle column is set to a length which can correspond to a width of a recording medium with a maximum size which can be printed in a printer, and a recording operation is performed while transporting a recording medium, without moving a recording head (scanning). In the configuration, it is preferable to adopt a configuration in which ink with high conductivity is assigned for a nozzle portion (nozzle column) which is located on the upstream side in the transport direction of a recording medium, and ink with low conductivity is assigned for a nozzle portion (nozzle column) which is located on the downstream side in the transport direction. In this manner, a recording medium is not easily charged by ink ejected from the nozzle portion (nozzle column) which is located on the upstream side, and it is possible to relieve a situation in which ink ejected from a nozzle portion (nozzle column) which is located on the downstream side of the nozzle resists to the recording medium, and the ink (mist) is attached to a nozzle forming face, or the like, of a recording head. In addition, since a recording medium or a medium supporting body is not easily charged, ink ejected from a recording head is more accurately landed to a target position on a recording medium. In this manner, it is possible to suppress deterioration in an image quality of a recorded image, or the like.

In the above described embodiment, an ink jet recording head 10 has been exemplified as a liquid ejecting head; however, the invention also can be applied to another liquid ejecting head in which liquid is ejected from a nozzle portion. For example, it is also possible to apply the invention to a coloring material ejecting head which is used when manufacturing a color filter of a liquid crystal display, or the like, an electrode material ejecting head which is used when forming an electrode of an organic electroluminescence (EL) display, a surface light emission display (FED), or the like, and a bio-organic material ejecting head which is used when manufacturing biochip (biochemical element), or the like. The coloring material ejecting head for a display manufacturing device ejects a solution of each coloring material of R (red), G (green), and B (blue) as a type of liquid. In addition, the electrode material ejecting head for an electrode forming device ejects a liquid-type electrode material as a type of liquid, and the bio-organic material ejecting head for a chip manufacturing device ejects a solution of a bio-organic material as a type of liquid.

The entire disclosure of Japanese Patent Application No. 2016-122492, filed Jun. 21, 2016 is expressly incorporated by reference herein.

What is claimed is:

1. A liquid ejecting head which includes a nozzle forming face onto which a nozzle portion from which liquid is ejected is formed to be open,
wherein a liquid repellent film including fluorine is formed on the nozzle forming face through a base film interposed therebetween, and
wherein a total thickness of the base film is 670 [nm] or less.

2. The liquid ejecting head according to claim 1,
wherein a signal intensity of a molecular weight 301 in the liquid repellent film obtained by using a time-of-flight secondary ion mass analysis method is 0.00005 or more and 0.00020 or less.

3. The liquid ejecting head according to claim 2,
wherein the signal intensity is 0.00005 or more and 0.00015 or less, preferably.

4. The liquid ejecting head according to claim 1,
wherein the base film is configured of at least one or more of a silicon oxide film, a tantalum oxide film, and a plasma polymerized film of a silicon material.

5. A liquid ejecting apparatus comprising:
the liquid ejecting head according to claim 1.

6. A liquid ejecting apparatus comprising:
the liquid ejecting head according to claim 2.

7. A liquid ejecting apparatus comprising:
the liquid ejecting head according to claim 3.

8. A liquid ejecting apparatus comprising:
the liquid ejecting head according to claim 4.
